(19) United States
(12) Patent Application Publication
(10) Pub. No.: US 2001/0021307 A1
(43) Pub. Date: Sep. 13, 2001

(54) Method and apparatus for capturing and recording audio and video data on optical storage media

(76) Inventors: Zhihong Wang, Singapore (SG); Kay Hing Tan, Singapore (SG); Kim Seng Lim, Singapore (SG); Gim Eng Low, Singapore (SG); David Y.S. Tung, Singapore (SG); Honggang Wu, Singapore (SG)

Correspondence Address: COLUMBIA IP LAW GROUP, PC, 4900 SW MEADOWS ROAD, SUITE 109, LAKE OSWEGO, OR, 97035, US

(21) Appl. No.: 09/753,131

(22) Filed: Dec. 28, 2000

(30) Foreign Application Priority Data
Jan. 6, 2000 (SG) 200000008-3

(51) Int. Cl. H04N 5/76; H04N 5/781

(52) U.S. Cl. 386/96; 386/111; 386/126

(57) ABSTRACT

The present invention is a digital audio and video recorder that captures audio and video data in real time, replays and records on Compact Disc CD Read or Read Write optical storage media on the fly, The system architecture of isolating high frequency video components minimizes noise and outputs MPEG compliant signals. By interfacing the present invention with an audio drive that accepts streaming data, the present invention not only captures and replays video in real time without a host processor, but also records audio and video streams on optical storage media without the need for buffer management overhead. As such, a consumer digital audio and video recorder is realized.

### FIELD OF THE INVENTION

The present invention relates to a digital audio and video recorder. In particular, the present invention pertains to a consumer, digital audio and video recorder that captures audio and video data, replays and records on Compact Disc CD Read or Read Write storage media all in real time.

### BACKGROUND OF THE INVENTION

Although analog audio and video recorders or video cassette recorders adorn the living rooms of virtually every household, the consumer digital audio and video recorder is not available commercially.

Dazzle Multimedia, Inc. pioneered an external module known as Dazzle that allowed users to feed live composite video stream and analog audio data through it and via a parallel port of a personal computer. See, for example, U.S. Design Pat. No. 411,523. A real-time video encoder in the module encoded video data while audio signals were encoded with the host processor. With Dazzle and its successors, camcorder users could record and transfer audio and video information to a personal computer as MPEG1 files that could be posted on the web or recorded in a CD-R or Zip Drive format.

Dazzle has not gained wide spread consumer acceptance because the video quality was poor compared to those offered by VHS video cassette tapes and Laser Disc. Furthermore, the replay of audio data was not satisfactory because Dazzle did not have CD-DA recorder functionality. Above all, the audio and video data captured with Dazzle have to be reformatted using special authoring tools and recording on storage media required several pass processes.

Next to introduce a product that had digital audio/video functionality was an add on card for personal computer such as one by Optibase Inc. The Optibase VCD encoding system achieved MPEG1 audio and video encoding in real time. Such products were usually used in VCD mastering applications and costing between US$ 2,000 to 20,000 depending on configuration. MPEG audio and video encoding was accomplished by hardware (MPEG video only encoder plus audio DSP) with system multiplex done by host processor. Once again, the encoded compressed data were stored on hard disk and transferred eventually onto CD-RW after multiple passes of authoring and formatting.

Besides sharing most of the disadvantages of Dazzle, the add-on card digital audio/video recorders were costly and meant for professional use.

More recently, Philips Semiconductors announced that it was bundling its Trimedia video and audio processor TM 1300 with Stream Machine Co.'s single chip MPEG-2 video codec SM2210 as an overall solution for digital audio/video recording applications. It is uncertain as to what extent can consumer products be produced economically using such processor and chip as the buffering overhead remains non-trivial.

The barriers in gaining wide spread acceptance among consumers for a digital audio/video recorder capable of encoding and replying audio and video signals simultaneously and recording on the fly on CD-R and CD-RW storage media are both economical and technical. On the one hand, the digital audio/video recorder must be comparable in price and quality as the analog audio/video recorder before consumers are prepared to forego the latter. On the other hand, the MPEG encoders and decoders available on the market require too much auxiliary memory and processing power the additional of which would put a digital audio/video recorder beyond the reach of the average consumers.

### OBJECT OF THE INVENTION

It is an object of the present invention to define a system of data and instruction interface for audio/video recording that minimizes the memory and host processor overhead of a digital audio/video recorder.

It is yet another object of the present invention to configure an operation system and embedded control elements so as to reconcile the separate demands of real time MPEG encoding and decoding as well as the CD-RW writing requirements.

It is an additional object of the present invention to actualize a real time MPEG video and audio encoding and decoding while writing on the fly to CD-RW storage media effectively and economically.

### SUMMARY OF THE INVENTION

The present invention is a digital audio and video recorder that captures audio and video data in real time, replays and records on Compact Disc CD Read or Read Write optical storage media on the fly. The system architecture of isolating high frequency video components minimizes noise and outputs MPEG compliant signals. By interfacing the present invention with an audio drive that accepts streaming data, the present invention not only captures and replays video in real time without a host processor, but also records audio and video streams on optical storage media without the need for buffer management overhead. As such, a consumer digital audio and video recorder is realized.

### BRIEF DESCRIPTION OF THE DRAWINGS

FIG. 1A is a prior art system architecture for implementing a digital audio and video recorder using a host processor.

FIG. 1B is a detailed block diagram of a MPEG audio video module that would be used in a prior art digital audio and video recorder as outlined in FIG. 1A.

FIG. 2 is a block diagram of a more recent prior art MPEG audio and video processor that may be used to implement a consumer digital audio and video recorder.

FIG. 3 is a block diagram of the present invention featuring an audio drive that accepts stream video signals and interfacing with a controller for not only replaying audio/video data in real time but also record audio/video data optical storage media simultaneously.

FIG. 4 is a detailed block diagram of the controller of the digital audio and video recorder as illustrated in FIG. 3.

FIG. 5A is a timing diagram of the controller in FIG. 4 when it initiates the recording mode of the optical drive.

FIG. 5B is a timing diagram of the controller in FIG. 5 when it initiates the termination of a recording session of the optical drive in FIG. 3.

### DETAILED DESCRIPTION OF THE INVENTION

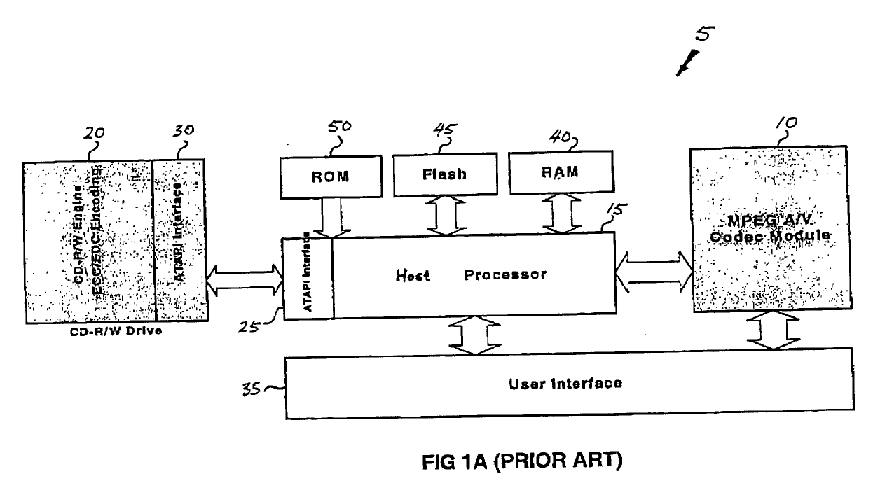

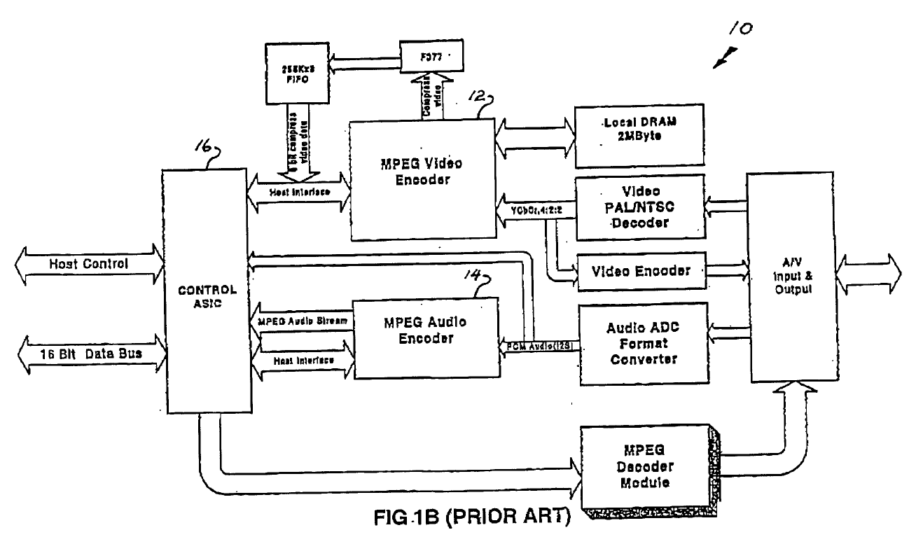

FIG. 1A is a prior art system architecture for implementing a digital audio and video recorder 5 using a host processor 15. The recorder 5 comprises at least a MPEG audio and video codec module 10, a data engine such as an off-theshelf CD-R/W drive 20 featuring ATAPI or IDE interfaces 25 and 30, an user interface 35, buffers 40 and 45, and finally memory 50. Except for the MPEG audio and video codec module, all the other key components are standardized and widely available. For instance, the host processor 15 is likely to be a 16-bit processor.

On the other hand, the MPEG audio and video module is likely to be a stand alone and complex block such as the one illustrated in FIG. 11B. The key components of a MPEG audio and video module 10 comprise at least one MPEG video encoder 12, at least one MPEG audio encoder 14, and at least one controller 16. Currently the codec module 10 is made from a myriad of components that were not designed to work together. For instance, the MPEG video encoder 12 is likely to be an encoder CLM 4111 from C-Cube, and the audio encoder 14 an ADSP2181 from Analog Devices. The controller 16 will most likely be a complicated proprietary application specific integrated circuit (ASIC) that has to perform interfacing between devices with different host requirements.

The challenge of integrating a digital audio and video recorder for the consumer market such as the one shown in FIG. 1 A is the multiplexing of independent audio and video stream into full MPEG compliant system stream, such that during playback, audio and synchronization is adhered. Due to the independent clocking and processor latency of the video and audio processors such as the one illustrated in FIG. 1B, it is fundamentally impossible to synchronize the two elementary streams given the current platform.

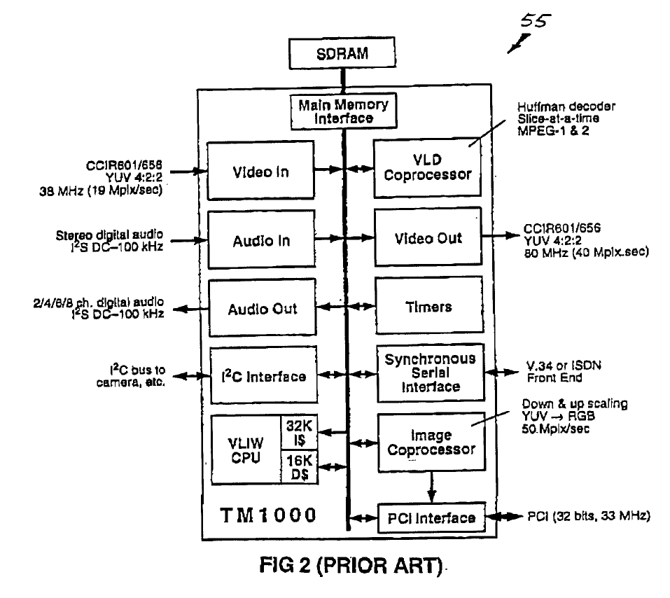

FIG. 2 is a block diagram of a more recent MPEG audio and video processor 55 that may be used to implement a digital audio and video recorder. Processor 55 is a system description of the Trimedia processor that Philips Semiconductors is bundling with Stream Machine Co.'s single chip MPEG-2 video codec SM2210 as an overall solution for digital audio/video recording applications. It is uncertain as to what extent can consumer products be produced economically using such processor and chip as the buffering overhead remains non-trivial.

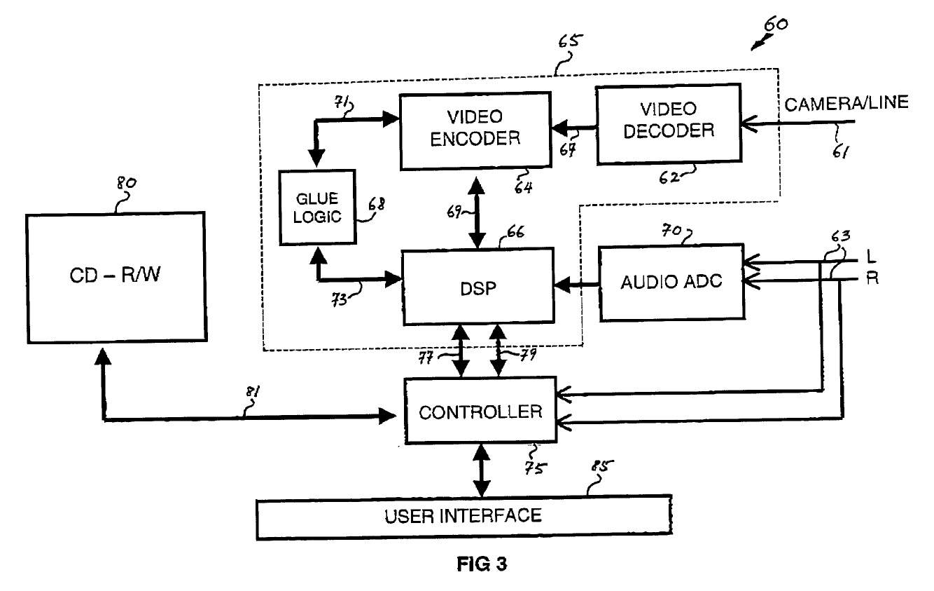

FIG. 3 is a block diagram of the digital audio and video recorder 60 featuring an audio engine drive 80 that accepts streaming audio and video signals and interfaces with a controller 75 for not only replaying audio and video data in real time but also records audio and video data on optical storage media simultaneously. The present invention 60 comprises an integrated video board 65, an audio A/D converter 70, the controller 75, the drive 80 and an user interface 85. The video board 65 captures, digitizes and compresses video data it receives as input via lines 61. Similarly, the audio A/D converter 70 performs the same function for the audio data that its receives via lines 63. It should be understood by one skilled in the art that ciruitry for power source and also replay function are required for the digital audio and video recorder 60 to work properly. They are not shown explicitly in order not to obscure the novel features of the present invention. Similarly, well known components for optical drive, analog to digital converter, and user interface are not illustrated so as not to detract from the presentation of digital recorder below.

Referring again to FIG. 3, the video board 65 comprises a video decoder 62, a video encoder 64, a digital signal processor (DSP) 66 and a glue logic 68. All the key modules of the video board 65 are high frequency components. The present invention groups and isolates these high frequency components on a single board for two principal reasons: (1) it minimizes noise and enables the output to be MPEG compliant; and (2) it allows further integration of the signal path. The architecture of the video board constitutes one of the novel features of the present invention. The video decoder 62 takes as input video signals from line 61. Typical video inputs comprises analog signals from either a camcorder, VCR, television broadcast and other video sources. As and when the video signals are supplied to the line 61, the decoder 62 captures and digitizes them before outputting them to the video encoder 64 via path 67. The video encoder 64 compresses the digitized video signals before transferring them to the DSP 66. Interposed between the video encoder 64 and the DSP 66 is the glue logic 68 that synchronizes the compressed video signals with the compressed audio signals from the audio A/D converter 70 over paths 71 and 73 respectively.

In the preferred embodiment of the present invention, the video decoder 62 is a SAA7113 chip from Philips. Similarly, the video encoder 64 comprises a Z1011 chip from Zapex Research. The DSP 66 is a VC5402 from Texas Instruments. Finally, the glue logic 68 comprises a EPM7064 chip from Altera.

Again in FIG. 3, the audio signal path of the recorder 60 is spearheaded by the audio A/D converter 70. Converter 70 captures audio signals via the line 63 and digitizes them before providing them as input to the DSP 66 to be encoded and synchronized with the compressed video signals. At the same time, audio signals are also provided as input to the controller 75 for direct replay. The description of the controller 70 and its interaction with the DSP 66 and the CD-RW drive 80 will be elaborated below.

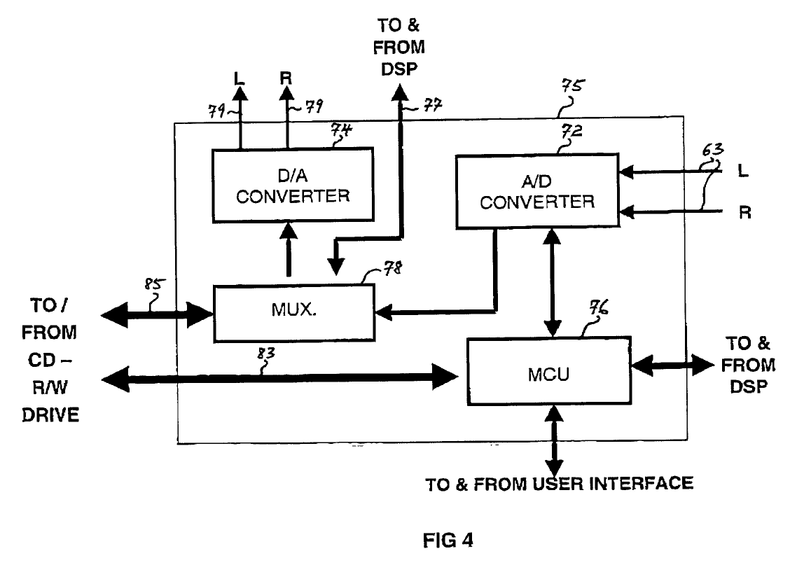

FIG. 4 is a detailed block diagram of the cortroller 75 of the digital audio and video recorder 60 of the present invention. The controller 75 comprises a analog-to-digital converter (ADC) 72, a digital-to-analog converter (DAC) 74, a micro controller unit (MCU) 76 and a multiplexer (MUX) 78. The ADC 72 receives as input audio signals via lines 63 just as the Audio ADC 70; it digitizes them and transfer them to the MUX 78 and outputs to replay via the DAC 74 should it receives the command from the user interface 85 to do so. The MUX 78 is also coupled to the CD-RW drive 80 for transferring compressed and synchronized audio and video data thereto upon commands from the DSP and MCU respectively. The MCU 76 is a controller from Hitachi for coordinating the recording function of the recorder 60. The MCU 76 is coupled to the DSP 66 via lines 77 and 79 on one hand and the CD-RW drive 80 via line 81 on the other hand. The ability of the controller to coordinate the recording of compressed AN streaming data with the CD-RW drive without external memory is also another novel feature of the present invention.

In FIG. 4, the CD-RW drive 80 represents generically a class of audio engines that are meant to record audio signals only. It differs from the data engines such as the CD-RW drive 20 in FIG. 1A by the omission of the ATAPI or IDE interface and also logic for synchronizing data recording. In general, data engines receives data input in burst mode and are not suitable to record live feed video and audio signals that transmit naturally in streaming data mode. MPEG requires compressed audio and video signals to be written at a data rate of 1.5 Mbps. Although audio engine records data in streaming mode, its tolerance for detecting the critical headers of MPEG tracks is undesirable. In other words, the inability of audio engines to detect the link block and pregap of MPEG track may cause non-reversible loss of data.

In the preferred embodiment of the present invention, the CD-RW drive 80 incorporates an optical drive unit CDL4009 and an audio engine chipset known as CDU3800 both from Philips, Instead of the standard PC CD block encoder and decoder plus the ATAPI interface, CD-RW drive has a serial command interface called DSA-R for facilitating direct data exchange between the CD engine and DSP. It should be understood by one skilled in the art that any audio engine having similar characteristics as the Philips drive may be used to implement the present invention.

To meet the constraints of a digital audio and video recorder for the consumer market, the recorder has to achieve real time replay and recording on optical storage media with minimum amount of buffering and yet meet the cost per unit ceiling. With reference to the present invention as shown in FIG. 3, the MC U 76 of the controller 75 must coordinate the process of transferring streaming data from the DSP 66 with the writing process of the CD-RW drive 80.

Without a common dock and any memory, the present invention must coordinate the interactions between the DSP and the CR-RW drive while ensuring the transmission of streaming data between the two is synchronized in order to prevent data loss or include noise.

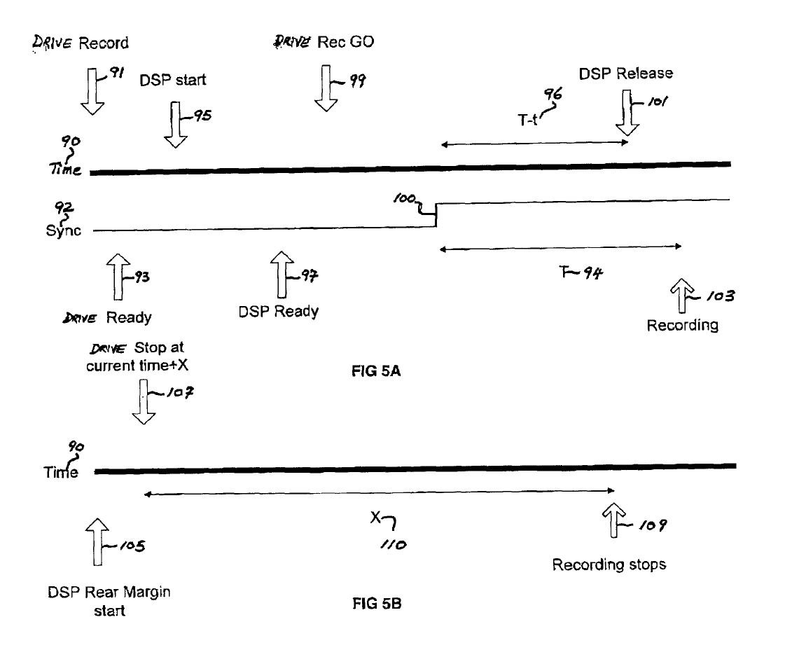

The present invention overcomes the cap on buffering and meets the MPEG synchronization requirement by turning the MCU 76 into a master and the CD-RW drive 80 a slave. FIGS. 5A and 5B are timing diagrams of MCU 76 during the start and finish of the recording of streaming data by the CD-RW drive 80. First, the MCU 76 sends commands over path 83 to CD-RW drive 80 to prepare it for recording. This is depicted in steps 91 and 93 of FIG. 5A. Note CD-RW drive 80 has a new port SYN 92 that is coupled to the MCU 76 over path 83 for sending it a acknowledgement signal. At this juncture, the MCU 76 also configures the DSP 66 to perform audio and video encoding in step 97 of FIG. 5A. Here, the DSP configures the link and pregap length, the number of front margin and rear margin according to MPEG requirements. It is important to note that these configuraton are all variables instead of the standard fixed length in data engine transmission. When both the CD-RW drive 80 and the DSP 66 are ready as shown in step 99 of FIG. 5A, the MCU 76 sends a Start command to the CD-RW drive 80 and monitors the SYN port of the CD-RW drive 80. When the SYN 92 goes high as shown in step 100 in FIG. 5A, the CD-RW drive 80 records T milliseconds before actually recording streaming data from the DSP 66. At the same time, the MCU 76 sends a Release command T-t milliseconds later to the DSP 66 to transfer output via path 85. Once the recording is started, the streaming data is synchronized between the CD-RW drive 80 and the DSP 66.

To terminate recording of streaming data between the CD-RW drive 80 and the DSP 66, the MCU 76 sends a Stop command to the OSP 66 via the path 79. Upon receiving the Stop command from the MCU 76, the DSP 66 flushes its data. The DSP 66 also starts to write a rear margin as shown in step 105 in FIG. 5B. Thereafter, the DSP 66 sends a signal to the MCU 76. The MCU 76 sends a termination signal to the CD-RW drive 80 as illustrated in step 107 of FIG. 5B. The CD-RW drive 80 stops recording after X milliseconds later as shown in step 109.

With the synchronization scheme outlined in FIGS. 5A and 5B, a low cost digital audio and video recorder can replay and record MPEG compliant audio and video data on optical storage media in real time without any buffering overhead. Similarly the adoption of variable length for link and pregap for MPEG track permits the present invention to accommodate the wide tolerance of audio engine, hence ensuring integrity and fidelity of recorded data. Therefore, the present invention presents a real alternative to the stand alone analog video cassette recorders.

The present invention may be embodied in other specific forms without departing from the spirit or essential characteristics thereof. The presently disclosed embodiments are, therefore, to be considered in all respects as illustrative and not restrictive, the scope of the invention being indicated by the appended claims and all changes which come within the meaning and range of equivalency of the claims are, therefore, to be embraced therein. For instance, the CD-RW drive may become the master and the DSP the slave in an alternative configuration.

What is claimed:

1. A system for capturing and recording audio and video signals in real time, said system comprising:
at least one video decoding means for receiving video signals;
at least one video encoding means coupled to said video decoding means for receiving therefrom said video signals, said video signals being encoded into a predetermined format;
at least one audio converting means for receiving audio signals;
at least one signal processing means coupled to said video encoding means and said audio converting means for receiving therefrom formatted video signals and audio signals;
at least one controller means coupled to said signal processing means for receiving therefrom composite audio and video signals, said controller means further receiving audio and video signals;
at least one optical recording means coupled to said signal processing means and said controller means for receiving and recording said composite audio and video signals on optical storage media, said optical recording means communicating with said signal processing means over said controller means,
whereby said system records audio and video signals in real time and without a host processor and memory overhead.

2. A method for capturing and recording audio and video signals in real time, said method comprising the steps of:
capturing video signals with at least one video decoding means:
formatting said video signals with at least one video encoding means coupled to said video decoding means, said video signals being encoded into a predetermined format;
capturing audio signals with at least one audio converting means;
receiving formatted video signals and audio signals from at least one signal processing means coupled to said video encoding means and said audio converting means;
receiving composite audio and video signals from at least one controller means, said controller means further receiving audio and video signals;
receiving and recording said composite audio and video signals on optical storage media with at least one optical recording means coupled to said signal processing means and said controller means, said optical recording means communicating with said signal processing means over said processing means,
whereby said method records audio and video signals in real time and without a host processor and memory overhead.

3. A method for coordinating the transmission and recording of compressed audio and video data on optical storage media with an audio optical recording means in a system for capturing and recording of audio and video data in real time, said system comprising at least one video encoding means, an audio encoding means, and a controller means, said method comprising the steps of:
preparing said audio optical recording means for recording b y requesting with said controller means for a synchronization signal therefrom;
configuring said audio encoding means and said video encoding means with said controller means by inserting variable ink and pregap length, front and back margins in formatting MPEG tracks;
monitoring said audio optical recording means with said controller means for the return of said synchronization signal before activating the recording function of said audio optical recording means after a first predetermined delay;
releasing said audio encoding means and said video encoding means to transfer compressed audio and video data to said audio optical recording means after a second predetermined delay,
whereby said method actualizes the real time recording of compressed audio and video data on optical storage media with an audio optical recording means without memory overhead and synchronization of data transfer being controlled intelligently by the adjustment of variable ink and pregap length in MPEG tracks.
